(19) United States
(12) Patent Application Publication
(10) Pub. No.: US 2009/0290938 A1
(43) Pub. Date: Nov. 26, 2009

(54) SOIL PASTEURIZING APPARATUS AND METHOD USING EXHAUST GAS

(76) Inventors: Hisatoshi Asaoka, Niigata (JP); Norio Kikuchi, Niigata (JP); Satoshi Sato, Niigata (JP)

Correspondence Address: SUGHRUE MION, PLLC, 2100 PENNSYLVANIA AVENUE, N.W., SUITE 800, WASHINGTON, DC, 20037, US

(21) Appl. No.: 12/088,753

(22) PCT Filed: Mar. 26, 2007
(86) PCT No.: PCT/JP2007/056223

§ 371 Date: Mar. 31, 2008

(30) Foreign Application Priority Data
Feb. 1, 2007 (JP) 2007 023332

(51) Int. Cl. B09C 1/00

(52) U.S. Cl. 405/128.45

(57) ABSTRACT

In agriculture, one of the most important issues is the extent to which the yield of high quality crops can be increased while saving labor and reducing costs. However, there are many problems in that so-called injuries of crops due to continuous cropping and other causes seriously reduce productivity. The present invention provides an apparatus and a method that can pasteurize soil using gases emitted from the engine of a tractor, while at the same time, carbon dioxide, sulfur oxides, and other acidic fumes in exhaust gas are fixed as calcium salts with slaked lime that has been applied in advance on the soil to be pasteurized, and these gaseous components can, as much as possible, be prevented from escaping into the atmosphere.

### TECHNICAL FIELD

The present invention relates to an apparatus for pasteurizing soil, and to a method of using the same, by utilizing the heat and components of gases exhausted from an internal combustion engine of a tractor or other farm machine.

One of the most important issues in agriculture is the yield of high quality agriculture crops that can be obtained while minimizing labor and reducing costs. However, many farmers tend to repeatedly cultivate the same kind of plant in the same agricultural field, depending upon the climate and for economic reasons. As a result, damage from nematodes, soil pathogenic microorganisms, and other factors may cause some significant problems relating to a seriously reduced productivity from so-called injuries of crops due to continuous cropping, poor soil fertility, and the like.

The present invention relates to a novel technical field that provides a means for solving these problems, that is, soil is pasteurized using high temperature exhaust gas from the engine of a tractor or other farm machine. At the same time, the gaseous components such as nitrogen oxides, carbon dioxide, sulfur oxides in exhaust gas are fixed to calcium salts with quicklime and slaked lime, which have been applied in advance, and these gaseous components can be prevented from escaping into the atmosphere.

### BACKGROUND ART

Conventionally, various methods that have been used to prevent the injuries due to continuous cropping, that is, the use of cover crops, crop rotation, flooding, plant cross-breeding, soil solarization (e.g., Patent Document 1), steaming (e.g., Patent Document 2), hot water (e.g., Patent Document 3), microwaves (e.g., Patent Document 4), and numerous types of agricultural chemicals.

Cover cropping is a method in which a field is left fallow before damage by soil pests becomes serious, and the same field is then reused when the effects of these damage have decreased; however, this method cannot be employed by farmers who do not have alternative fields. Crop rotation is a cropping practice in which crops that are not hosts to the same soil pests are cultivated alternately. However, the selection of such crops is limited, and it is difficult to control crop pests by using crop rotation alone. Flooding is a technique in which the amount of oxygen available for respiration is reduced by submerging the field in water from approximately July to September. As a result, naturally occurring substances such as organic acids, methane, hydrogen sulfide, and other toxic substances are increased, and the prevalence of soil pests is reduced. However, flooding may take two years or more to kill nematode eggs, and such techniques are suitable for only certain large-scale of monoculture areas that have abundant water and already have a controlled irrigation system. Accordingly, almost no farmers employ such techniques.

Plant cross-breeding is a field in which considerable achievements have been made by the development of modern biotechnology; however, safety problems of the new crops and the possibility that there will be damage due to soil-borne diseases adapting to the new crops cannot be ignored.

Soil solarization is effective because solar energy available in the environment can be used for soil pasteurization; however, there are some problems with this method. It is climate-dependent and in some cases, it requires the field to be fallow for the summer.

Steaming is a good method of soil disinfection. However, steam sterilization or pasteurization of large agricultural fields may not be practical because of the difficulty in maintaining expensive steam boiler machines that will only be used a few times a year. The hot water treatment is a method in which water that is heated to 95° C. or higher is poured onto cropland. However, soil characteristics are easily altered by water of high temperature, and it is difficult to apply it to hilly areas or sloping fields. The use of lasers and electromagnetic waves will destroy the roots of old plants and kill all soil organisms. These methods are particularly suited for use in greenhouses and some small nursery fields. Accordingly, they cannot be generally used.

In modern agriculture, the use of synthetic chemical pesticides to control pests of agricultural crops has come to assume a very important role. There are a great variety of agricultural chemicals that are acutely toxic, carcinogenic or otherwise threaten public health and the environment. Methyl bromide can be used (e.g., Patent Document 5), for soil fumigation as an effective pest control chemical for many nursery crops, although it readily leaks out and escapes into the atmosphere; consequently, it leaves no toxic residue in the soil or in crops. However, because these chemicals are very toxic to humans and domestic animals, great care must be taken in their handling. After fumigation by using methyl bromide, crops cannot be planted until all of the methyl bromide has escaped.

Methyl bromide is an effective pesticide, but it has serious problems. Vaporized methyl bromide depletes stratospheric ozone, which protects life on Earth from harmful ultraviolet radiation from the sun. Therefore, the use of methyl bromide is gradually being phased out.

### REFERENCES CITED

[1] Japanese Laid-open Patent Application No. 2004-201534
[2] Japanese Laid-open Patent Application No. 2005-65574
[3] Japanese Laid-open Patent Application No. 2005-102
[4] Japanese Laid-open Patent Application No. 2004-298026
[5] Japanese Laid-open Patent Application No. 1993-255025

### DISCLOSURE OF INVENTION

### Problems the Invention is Intended to Solve

In agricultural crop production, which is directly connected with human food problems, immediate solutions are currently being sought in order to reduce the use of agricultural chemicals and to obtain high quality food in a safe manner. An object of the present invention is to provide a soil pasteurizing apparatus and a soil pasteurizing method that can pasteurize the soil in fields, orchards, flower gardens, agricultural greenhouses and the like. The apparatus can be mounted on, for example, a tractor or other farm machine, and it can use the heat and the components of gases exhausted from the engine without incurring high costs.

Gases emitted from tractors, automobiles, and other vehicles currently operating in the world meet the environmental emission standards of each country. However, these gases contain the harmful components such as nitrogen oxides (NOₓ), carbon monoxide (CO), carbon dioxide (CO₂), sulfur dioxide (SO₂), hydrocarbons (HC) and particulate matter (PM). Among these components, HC and PM, which may enter into the human body via the respiratory system, are particularly harmful. However, these components have low solubility in water; in the present invention, many of these components are held in the soil, and the amounts of these components that penetrated into plants are thought to be negligible.

TABLE 1 shows the analytical values of exhaust gas from a 23-horsepower tractor employed in the present invention and a gasoline-burning car under idling conditions for comparison.

TABLE 1
Exhaust gas analysis

| Components | Tractor | Gasoline-powered car |
|---|---|---|
| HC (ppm) *1 | 140 | 50 |
| NOx (ppm) *2 | 160 | <2.5 |
| SOx (ppm) *3 | <1.5 | <1.5 |
| CO (ppm) *4 | 320 | 100 |
| CO₂ (%) *5 | 2.4 | 14.6 |
| O₂ (%) *6 | 17.6 | 0 |
| N₂ (%) *7 | 80.0 | 85.4 |
| H₂O (%) *8 | 2.8 | 17.6 |

Assay:
*1: Gas chromatography (FID)
*2: Chemiluminescence
*3: Ion chromatography
*4: Infrared absorption
*5, 7: Orsat method
*6: Zirconia sensor
*8: Hygroscopic tube method

The large differences in the HC and NOₓ (NO, NO₂ and other mixtures) components in exhaust gases of a tractor and a gasoline-powered car are due to the differences in the fuels that are used and due to the effects of the three-way catalytic convertor employed in the gasoline engine.

It has long been known that when lightning (thunder; electrical discharge) passes through air, NOₓ is produced, and this process affords usable nitrogenous fertilizer when it falls to the ground in rain. When NOₓ that is exhausted from a tractor is injected into the soil, the gases react with moisture in the soil to produce nitrous and nitric acids. A portion of these acids is reduced to ammonia by the activity of bacteria in the soil.

N₂+O₂=2NO (1)

2NO+O₂=2NO₂ (2)

2NO₂+H₂O=HNO₂+HNO₃ (3)

In the series of chemical reactions shown in chemical formulas (1), (2), and (3), NO₂ is a highly reactive and very toxic substance, and it is well known that NO₂ reacts with hydrocarbons in the presence of sunlight to produce peroxides (oxidants). However, in the absence of moisture, NO₂ remains as a gas in the soil where sunlight does not penetrate and attacks soil pests and pathogenic microorganisms while simultaneously affecting the germination of seeds and the growth of young plants.

In recent years, the accumulation of nitric and nitrous acid compounds attributable to chemical and organic fertilizer use at high concentrations in the farm fields worldwide is becoming a problem. Therefore, it is desired that the gases exhausted from tractors or other agricultural machines be cleaner than current levels. Specifically, if the main components of the gases were N₂, CO₂, and H₂O, the problem of eutrophication of the soil according to the present invention would be fully solved.

However, regarding exhaust gases that satisfy the current emission standards, acid components attributable to NOₓ are neutralized in the present invention by ionic reaction with moisture and slaked lime, i.e., calcium hydroxide. These acid components are converted to calcium salts, and SOₓ and CO₂ as components of exhaust gas related to acid rain and global warming are also fixed as harmless calcium salts in the same way.

Yet another object of the present invention is to provide a method of pasteurizing soil that can reduce the release of these harmful components into the atmosphere, in addition to the pasteurizing of soil by using exhaust gas.

The following are prior art document information.

US Patents, Nos.

| | | |
|---|---|---|
| 1,725,190 | August 1929 | Hicks |
| 2,598,121 | May 1952 | Hannibal |
| 2,988,026 | June 1961 | Heckathorn |
| 3,099,898 | August 1963 | Harris |

### Means of Solving the Problems

Primary features of the present invention will be described with reference to the attached drawings.

In a first aspect, the present invention is a soil pasteurization apparatus that uses exhaust gas from an engine 2 of a tractor 1 or other farm machine. The apparatus comprises a pipe 3 and a guide tube 4 for guiding exhaust gas from the engine 2 of the tractor 1 or other farm machine; a plurality of injectors 9 for injecting exhaust gas into soil at branching terminal portions of the guide tube 4; and a plurality of nozzles 14 and 15 for injecting exhaust gas into the soil at the lower end portion of the injectors 9; wherein the plurality of injectors 9 can be drawn and made to travel through the soil.

In a second aspect, the present invention is configured so that exhaust gas from the engine 2 of a tractor 1 or other farm machine is introduced into a distribution tube 5 in which an inner wall is an insulating structure employing a heat-resistant material through the above guide tube 4 composed of the pipe 3, 4a and a flexible tube 4b, of which an exterior is an insulating structure that employs a heat-resistant thermal insulator; a plurality of branching tubes 8 having flanges 6 are welded to the distribution tube 5; the injectors 9 on which flat face flanges 7 that correspond to the above flanges 6 are connected to the distribution tube 5 with the aid of bolts 10 and nuts 11 via heat-resistant packing; and exhaust gas is sent into the soil from the plurality of nozzles 14 and 15 disposed at the lower end portion of the injectors 9.

In a third aspect, the present invention comprises the distribution tube 5 and the injectors 9 integrated therewith are configured so as to be movable by large distances up and down in co-operation with a rotary device 16 of the tractor 1; and a manual elevating device 19 is provided having a handle 18 that can be rotated so that the depth of the injectors 9 in the soil can be finely adjusted and set.

In a fourth aspect, the present invention comprises the injectors 9 are boomerang-shaped plates that are curved in the forward direction, and the edges 12 of the front and the rear of a boomerang-shaped plate are set at an acute angle so that the resistance received from the soil can be reduced during drawing through the soil; the pipe 13, having a diameter that is slightly greater than the thickness of the boomerang-shaped plate, is welded and embedded in the middle of the plate; the injectors 9 having the pipe 13 are inserted into the soil; and the plurality of nozzles 14 and 15 that can emit exhaust gas from the distal end of the pipe 13 are provided.

In a fifth aspect, the present invention accordingly has an array of the branching tubes 8 provided to the distribution tube 5 is set in two horizontal rows so that the plate surfaces of all of the injectors 9 are parallel, resulting in the resistance received from the soil in the forward direction being reduced when the injectors 9 mounted on the branching tubes 8 are drawn through the soil by the tractor 1; and the arrays of a first row and a second row of injectors 9 are set so as to mutually form a zigzag and not overlap each other, wherein the distal ends of all of the injectors 9 are positioned at the same depth in the soil.

In a sixth aspect, the present invention has injectors 9 are disposed behind the rotary device 16 so that the lower ends of the injectors 9 can be inserted into and drawn through the soil while the soil is being cultivated.

In a seventh aspect, the present invention includes a method of pasteurizing soil by injecting exhaust gas from an engine 2 of the tractor 1 into soil using the soil pasteurization apparatus according to the first aspect; and the soil is pasteurized by the heat of the exhaust gas, or by the heat of the exhaust gas and the components of the exhaust gas.

In an eighth aspect, the present invention is a method in which quicklime or slaked lime is applied in advance on the soil to be pasteurized; exhaust gas is thereafter injected from the engine 2 of the tractor 1 into the soil; and acidic fumes contained in the exhaust gas that are harmful to human health, the environment, etc., are fixed as calcium salts in the presence of moisture, whereby the harmful gaseous components are prevented from escaping into the atmosphere.

### EFFECTS OF THE INVENTION

In manners such as those described above, the present invention can be practiced without incurring high costs because the form is one in which an apparatus that injects exhaust gas from an engine of a tractor or other farm machine into the soil. In other words, a tractor or another farm machine is easily obtainable, including ones that are already in use, and the present apparatus can be easily assembled in a workshop or at a work site.

That is to say, soil can be easily pasteurized at high efficiency by the heat and components of gases exhausted from an engine of a tractor or other farm machine on which an apparatus having a form such as that described above is disposed. Therefore, the soil pasteurization apparatus and the method of pasteurizing soil provide superior work efficiency, easy operation, and very wide applicability.

In the first aspect of the present invention, a novel and innovative soil pasteurization apparatus of using exhaust gas is provided. The soil of a prescribed width and area can be reliably pasteurized at high efficiency in the direction of travel by using a form in which there are lower end portions of a plurality of injectors 9, which are provided with nozzles 14 and 15. These nozzles can emit exhaust gas via a pipe 3 and a guide tube 4 connected to the exhaust port from an engine 2 of a tractor 1 while being drawn forward in the soil.

In the second aspect, the apparatus is one in which the pipe 3, the guide tube 4, and the distribution tube 5 are provided with an insulating construction to minimize heat loss from the exhaust gas, and therefore, exhaust gas can be injected into the soil at high temperature. The pluralities of injectors 9 are joined to the distribution tube 5 so as to be detachable, whereby malfunctions of the injectors 9 or other unexpected situations can be immediately corrected.

In the third aspect, the form is one in which the injectors 9 integrated with the distribution tube 5 can be moved up and down together with the movement of a rotary unit 16 that can lift up and down hydraulically. Therefore, during the soil pasteurization by the tractor 1, direction changes and movements for withdrawal can be made instantaneously. Furthermore, the prescribed depth of the injectors 9 in the soil can be adjusted accurately during soil pasteurization.

By studying results of the various types of injectors 9 that are drawn through the soil, it was found that a unique boomerang-shaped thin plate is a shape that has physical and technological strength and good durability.

In the fourth aspect, a configuration of injectors 9 is described in which a pipe 13 passing exhaust gas is welded to the middle area of the plate, and exhaust gas can be emitted from the nozzles 14 and 15 at the end of the pipe 13.

The plate surfaces of the injectors 9 are aligned in parallel and in tandem so as to break open the soil and move forward when the injectors 9 are drawn in the soil by the tractor 1. However, when the spacing width of the arrangement of the injector 9 is narrow, the soil is dug up and large grooves are left behind the apparatus as plowed the field with a plow. On the other hand, the grooves cannot be formed when the width of spacing of each of the injectors 9 is wide; the distribution of exhaust gas injected in the soil lacks uniformity.

In the fifth aspect, however, a configuration that solves this problem is described in which injectors 9 are aligned in two rows, and each of the injectors 9 in the second row are arrayed in the middle spaces of the first row having wide spacing.

In the sixth aspect, a configuration is provided in which the lower end portions of the injectors 9 are drawn through the soil while cultivating the soil or after the soil has been cultivated, whereby exhaust gas can be injected into the soil while farming.

In the seventh aspect, a method of pasteurizing soil is provided that allows nematodes and soil pathogenic microorganisms to be eliminated by at least one of the heat and the components of exhaust gas.

Furthermore, in an eighth aspect, the harmful acidic gaseous components in exhaust gas can be fixed as calcium salts according to ionic reactions of rain or sprayed water with quicklime or slaked lime applied in advance. Thus, the present invention aims to provide a new soil pasteurizing method for preventing environmental pollution that does not harm humans and domestic animals because harmful exhaust gases are not released into the atmosphere.

### BRIEF DESCRIPTION OF THE DRAWINGS

FIG. 1 is a rear perspective view of the present example;

FIG. 2 is an enlarged back surface view of the main part of the distribution tube 5 and the injectors 9 of the present example;

FIG. 3 is an enlarged view of a part of the boomerang-shaped injectors 9 of the present example; and

FIG. 4 is a cross-sectional view of the distal point of the injector 9 including the outlets for exhaust gas emission of the present example.

### PREFERRED EMBODIMENTS OF THE INVENTION

The present invention will be briefly described with reference to the accompanying drawings in which reference numerals are shown for parts while pointing out the effects of the present invention.

The present invention has a form in which a guide tube 4 is connected or can be connected to an exhaust outlet of an engine 2 of a tractor 1 or other farm machine that has already been purchased or is already in use. Therefore, by means of simple operations, merely by the apparatus traveling over the farmland soil can be automatically pasteurized, and at the low cost.

Thus, the present invention relates to a soil pasteurizing apparatus and to a method of using a high-temperature exhaust gas emitted from the nozzles 14 and 15 at the distal points of the injectors 9, which can be drawn through the soil simultaneously.

In the present invention, plural injectors 9 are aligned in parallel, and the lower distal points of all of the injectors 9 are inserted to the same depth in the soil while the tractor 1 is traveling. If the pressure resistance of the soil in the area close to the distal points of the injectors 9 is locally different due to differences in the depth in the soil, gas cannot be distributed uniformly. With the present invention, by considering the shape and alignment of the injector 9, the gases exhausted from the tractor 1 can be injected at a specific depth in the soil.

Furthermore, in the present invention, plant parasitic nematodes can be eradicated in a relatively short period of time by the components of exhaust gas that have been applied thereto. The exhaust gas may also be effective for soil born-pests and pathogenic microorganisms that hinder the growth and development of crops. However, it is difficult to stop the life cycle of egg→larva→adult→egg of these soil pests by using the components of exhaust gas alone. An important factor in disrupting these life cycles is temperature. For this reason, it is necessary to inject high temperature exhaust gas (about 140° C., but this differs depending on the machine) into the soil using an apparatus that can minimize heat loss by conductions as much as possible.

At high temperatures, the proteins of pest organisms are denatured and enzymes required for survival are inactivated. However, if the temperature is excessively high, beneficial soil organisms are destroyed, and plant nutrients are also decomposed, and consequently the vitality of the soil will be lost. Therefore, the temperature must be suitably controlled. For the purpose of maintaining a proper temperature of the soil, the speed of the tractor may be controlled so that it travels faster or slower in a reciprocating manner. The methods for maintaining the proper soil temperature may be arbitrarily selected depending on the climate of the area. Soil has poor heat conductivity and does not easily cool after being heated. It is necessary to maintain the temperature of the soil at 40° C. to 70° C. for about 30 minutes to destroy the eggs of soil pests. The farmed area may be temporarily covered and kept warm as desired by mulch or the like after the soil pasteurization.

In the present invention, quicklime or slaked lime is automatically or manually applied in advance on the soil to be pasteurized. Thereafter, exhaust gas is injected into the soil to be pasteurized without it leaking into the environment. The CO₂ and other components in the exhaust gas are related to global warming problems as described previously.

Additionally, in the present invention, there is an advantage that should be kept in mind, in the description of the specific examples, that crops can be immediately farmed immediately after a rain or when an appropriate amount of water has been applied after pasteurization. This is not the case for methyl bromide and many other fumigants.

### Example 1

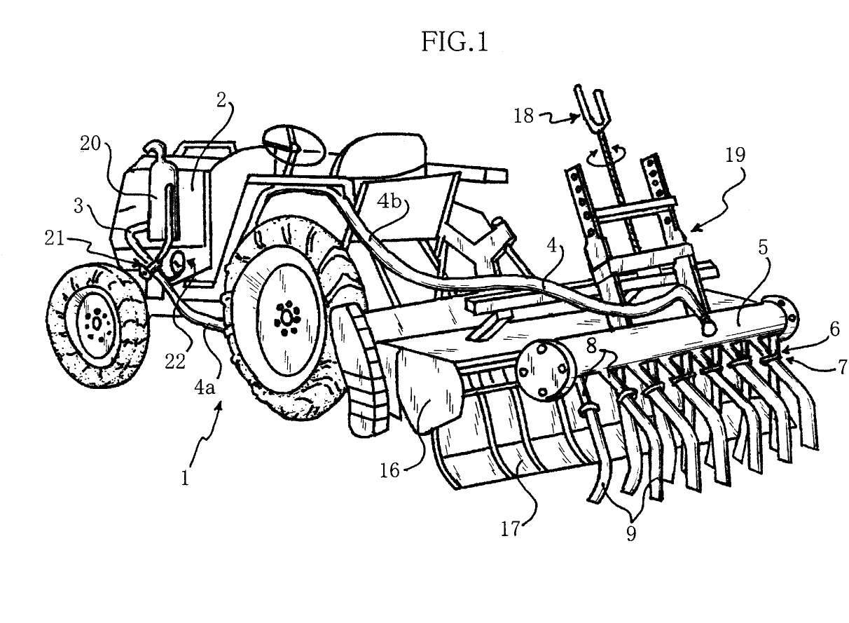

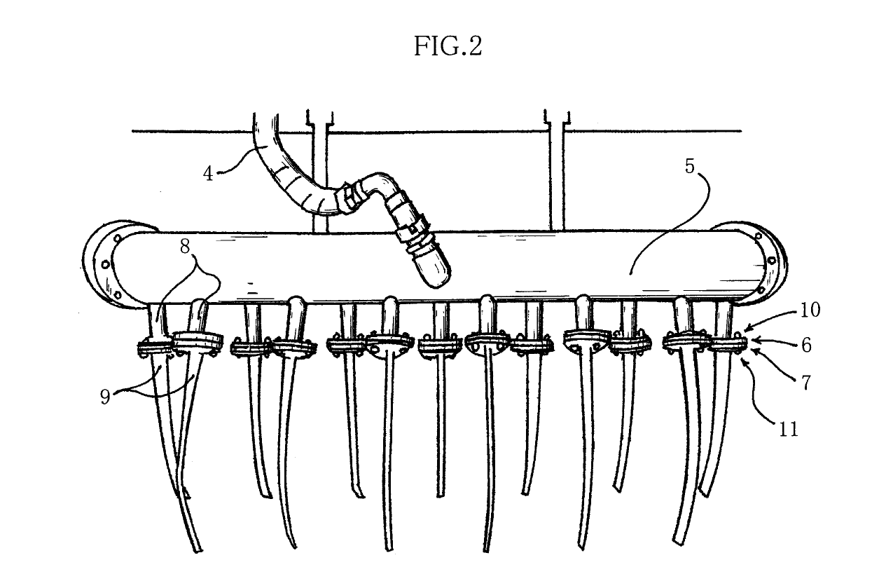

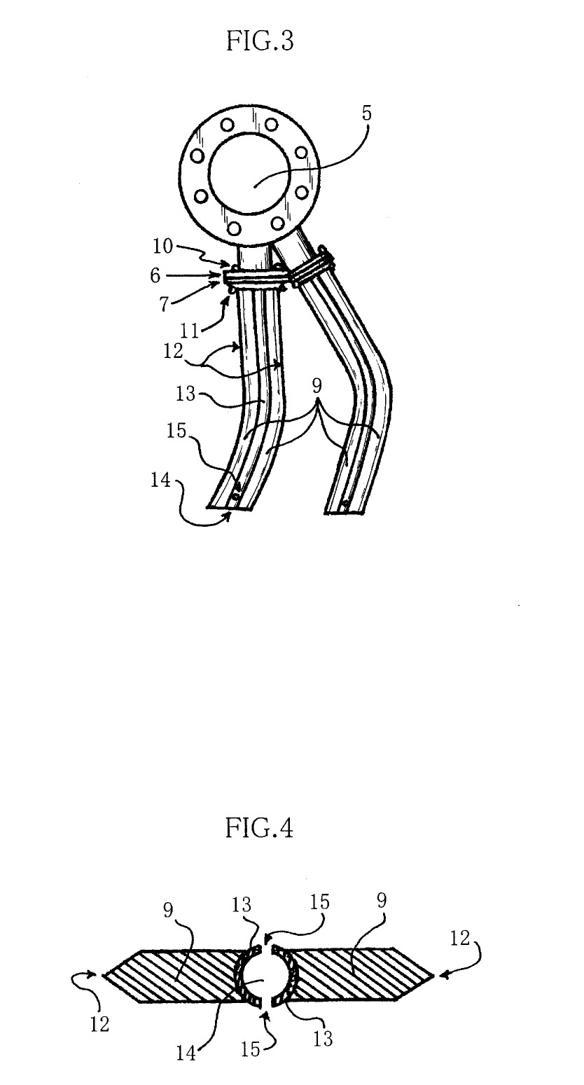

The gas exhausted from a tractor 1 passes through a pipe 3, which is connected to a switchable bi-directional gas cock 22. One of the directions allows exhaust gas to be released from a muffler 21 in case of emergency, and another direction is connected to the tube 4 in which a pressure gauge 23 is installed in order to detect any abnormalities in exhaust gas pressure, as shown in FIG. 1. During the soil pasteurization operations, the gas passes through the tube 4 composed of a pipe 4a and flexible tube 4b, and it then flows to the gas distribution tube 5. All of the exposed exteriors of the pipe 3 and the tube 4, including 4a and 4b, have to be wrapped with a heat-resistant insulator to avoid the loss of heat from the exhaust gas.

The inner wall of the distribution tube 5 has a lining with a heat resistant insulator, e.g., calcium silicate or the like. The distribution tube 5 is welded to a plurality of branching tubes 8 provided with flanges 6. Each of the injectors 9 are provided with a flat face flanges 7 fitting to branching tubes 8. They can be attached or detached with the aid of bolts 10 and nuts 11 via a heat resistant packing such as thin copper or the like. If the injectors 9 are broken or malfunction during the operation, these injectors can be removed and easily replaced.

The size, i.e., the inner diameter, outer diameter, length, and other parameters of the distribution tube 5, can be freely chosen in accordance with the horsepower of the tractor to be used and the sizes of the fields; however, the length is preferably set to be about the width of the tractor.

The injectors 9 are boomerang-shaped plates that are composed of steel or another material having sufficient strength to draw through the soil, and the plate can inject exhaust gas into the soil with good efficiency. The boomerang-shaped plate is slightly curved in the direction of forward advance of the tractor 1, and the edge of the plate is acutely angled so that it is possible to cut through the soil. The unique boomerang-shaped plate is designed to minimize the rising of the apparatus to the top of the soil when the injectors 9 are drawn forward through the soil. A metal pipe 13 having an open end to emit exhaust gas into the soil is welded along the middle part of the injector 9. Plural exhaust gas outlets 15 are arranged in the terminal portion of the pipe 13.

The pressure of the soil surrounding the injector 9 is not uniform, but each of the cross sections of the plates of the injectors 9 are aligned parallel to the ground surface during the pasteurization of the soil. The pressure resistance of the soil beneath the nozzles 14 is very small or nearly zero while the injectors 9 are drawn forward in the soil. Also, it is important that the distal points of the injectors 9 be at the same depth during the soil pasteurization. When the distal points of the injector 9 are not at the same depth, the distribution of the injected exhaust gas in the soil will not be uniform; consequently, more engine emissions would be required.

In the present example, the legs of an elevating device 19 are welded on the upper part of the distribution tube 5 so as to allow the exact setting of the injectors 9 at a predetermined depth in the soil. The elevating device 19 and distribution tube 15 assembly is firmly mounted with a thick steel board on the rotary frame, which can be hydraulically moved roughly in the vertical direction. The elevating device 19 can be independently moved a short distance in the vertical direction by a manual handle 18. Accordingly, the distribution tube 5 having the injector 9 can be set correctly at the prescribed depth in the soil.

The diameter of the pipe 13 welded in the middle portion of the injectors 9 can be changed according to the volumes of gases emitted by the tractor. If the quantity of exhaust is large, a larger pipe can be adopted. However, when single pipes are used instead of the injectors 9, they will need to be extremely large and strong. If the diameter of the pipe is large, large grooves may be formed after the pipe has been drawn through the soil. If the grooves are large, most of the gas may dissipate wastefully.

The cross-sectional view in FIG. 4 shows a streamlined form of the plate of injectors 9 that is preferable overall. However, when the alignment of the plates is in a single horizontal row with narrow spacing therebetween, soil will be accumulated in front of the plates and large grooves will form behind them. To solve this problem, the unique array of injectors 9 in the present invention as described above facilitates forward movement of the injectors 9 and decreases wasteful diffusion of exhaust gas.

In some cases, a soil-leveling board, such as the rotary cover 17, may be separately provided in order to level the soil behind the injectors 9 so as to eliminate slight unevenness caused by the second row of injectors 9.

Generally, the engine is disposed in front of the tractor, but in this case, the length of the gas guide tube 4 is greater than when the engine is at the rear of the tractor. Consequently, the greater the distance of the engine 2 from the distribution tube 5, the greater the decrease in the temperature of the exhaust gas. When the outdoor temperature is low, the exhaust gas may need to be heated.

In this case, a generator may be mounted on the tractor 1 to perform heating. A commercially available electrical heating unit that can provide heat by disposing it inside the tube 4 or the distribution tube 5. For example, the temperature of exhaust gas can be increased by 40 to 60° C. by using a 100-V, 2-kW nichrome wire. In such a case, the amounts of HC and PM contained in the exhaust gas may be reduced by a contact catalytic oxidation reaction on a red heater.

### Example 2

As previously described above, quicklime or slaked lime is automatically or manually applied on the soil to be pasteurized, and exhaust gas is injected into the soil in order to make it possible to pasteurize the soil without release of CO₂, SO₂, and other components in exhaust gas into the environment.

In order to study the reactions between exhaust gases and quicklime in the present example, 100 g of sandy soil (moisture: 6%, pH: 6.2) was placed in polypropylene bags, and 0.05, 0.1, 0.2, 0.5, 1.0, and 3.0 g of quicklime powder were added to the soil in the bags. A thermometer was placed in the bags and then the air in the bag was removed. One liter of exhaust gas from a gasoline engine was injected into each of the bags at room temperature. The bags were shaken occasionally to mix the contents and were left for 24 hours.

In this experiment, the temperature was increased by 6 to 12° C. in about 20 minutes due to the reaction of quicklime, some moisture in the soil, and exhaust gas, and the temperature then gradually decreased. The pH of the samples in which 0.05 g and 0.1 g of quicklime had been admixed was 6.6 and 6.8, but the other samples showed a pH of 8 or higher due to the amount of quicklime being excessive. A mixture of very small amounts of slaked lime and some amounts of the soil exhibited an alkalinity above pH 7. The pH values of 6.6 to 6.8 that were observed in the above experiments are indications of the reaction of slaked lime with CO₂ and other components in the exhaust gas.

The pH of soil is important in maintaining the healthy and favorable growth of plants. Acidic soils need some amounts of slaked lime and other alkaline compounds, but the amounts of alkaline components for the reaction of exhaust gas are preferably balanced stoichiometrically. In other words, the suitable amounts of slake lime or the like to be spread should be determined so that the pH of the soil does not vary after exhaust gas has been injected.

The reaction of quicklime with moisture in the exhaust gas or the soil evolves heat, and the heat is beneficial for the pasteurizing of soil containing pests, however, the effects of fixing NOₓ, CO₂, and the like are the same for slaked lime, which is cheaper and is easier to handle. The required amounts of slaked lime are related to the examples described below, but the amounts to be applied vary depending on how deep into the soil the injectors 9 can reach. For example, when the depth of the soil is A cm, the weight of the soil in A cm³ is measured. Based on the result, the total weight of the surface area of 1 m² at a depth of A cm is calculated, and a range of 0.01 to 3 wt %, and more preferably 0.05 to 0.2 wt %, per unit weight of slaked lime is uniformly applied on the soil in the field. The required amounts of slaked lime for the entire field surface area (m²) can be easily calculated from the obtained amounts per unit surface area.

After the slaked lime has been applied or is simultaneously applied in the field, the pasteurization by injecting high temperature exhaust gas into the soil is carried out by mixing the soil using the rotary device 16 of the tractor. When exhaust gas having a low oxygen concentration is injected into the soil with the injectors 9 at a depth of 20 cm, soil pests in the soil of both upper and lower layers of about 5 cm in width in the immediate vicinity of the distal points of injectors 9 will be temporarily exposed to an oxygen-deficient state. In the next step, the depth of the injectors 9 is placed at a shallower depth of 10 cm in the soil and pasteurized again. Most of the soil from a depth of 25 cm up to the soil surface can be pasteurized in this way.

The degrees of dispersion and the heat transfer from the gas in the soil vary greatly depending on the clay content of the soil, the organic matter content, the temperature, the humidity, and other factors. Therefore, the depths of the injectors 9 in the soil should be adjusted according to the characteristics of the soil so that the soil can be evenly and satisfactorily pasteurized by heat and diffusion of the components of the exhaust gas.

### Example 3

Nematodes were collected (August 9) from the soil around the roots of garden peas that had shown symptoms of root rotting, wilting, etc., to study the direct effects of exhaust gas components in the present invention. The nematodes were detected by using a microscope (Keyence Co. Ltd., Keyence VH-5000). About 50 g of soil was spread out thinly in a plastic container (7 cm×17 cm×1.5 cm) and this was carefully examined using a 75× lens. Nematodes need to be handled with the greatest care because they are very sensitive to high temperatures, dry conditions, and intense light.

A very small amounts of moisture was sprayed in advance on the inner wall of 10 cm³ transparent glass vials, and 5 nematodes were placed in the each vial; then, exhaust gas from a gasoline engine was injected therein at a room temperature of 32° C., and this was maintained at the same temperature.

In the following experiments, three exhaust gas compositions (vol %) were used, i.e., A (100% exhaust gas), B (80% exhaust gas and 20% air), and C (60% exhaust gas and 40% air). Movements of nematodes in the vial were examined with an ordinary optical microscope, and they were judged to be dead when they did not move in the thin film of water on the glass wall for 30 seconds or longer.

Nematodes can survive for three hours or even longer when only air is used under the same conditions.

The results are shown in TABLE 2. Specifically, the effect was that the nematodes died in a short time at a temperature of 32° C. even using cleaner exhaust gas from a gasoline-powered car than that from a tractor.

TABLE 2
Number of dead nematodes

| | 10 min. | 30 min. | 72 min. |
|---|---|---|---|
| A | 5 | — | — |
| B | 1 | 4 | — |
| C | 0 | 2 | 3 |

### Example 4

Slaked lime at 303 g/m², corresponding to a concentration of 0.1% was applied on a clayey acidic soil that had never been cultivated with crops and contained substantially no fertilizer or tillage, and then the soil was plowed without exhaust gas, and this was called A. In another case, the apparatus of the present invention was used to insert the injectors 9 to a depth of 20 cm in the various parts of the soil A, that is, the speed of engine rotation was set to 2,000 to 2,300 rpm, the flow rate of exhaust gas was 1.07 to 1.80 m³/min, and the driving speed was set to 1.5 to 1.8 m/min. Under these conditions, the pasteurization treatments were carried out 2, 4, and 6 times to obtain the soils B, C, and D, respectively. However, the injectors 9 were set to a depth of 10 cm for half of the even numbered times.

Seeds of Japanese radish were sowed in the soil after each of the treatments. Also, 5 to 6 kg of the each of soils A, B, C and D were collected at a depth of about 15 cm, and the pH, the total nitrogen, nitrate nitrogen, and nitrite nitrogen therein were measured. The four types of soil mentioned above were also used in a germination test of cabbage in a greenhouse.

The observed pH of A was different from that of B, C, and D is due to the reaction of slaked lime with CO₂ and other components in the exhaust gas, as described in Example 2. The nitrate and nitrite nitrogen content was about 1/150 that of the total nitrogen content, and significant differences were not observed among the 2 to 6 treatments times. The analytical results of these soils are shown in TABLE 3.

TABLE 3
Analytical results (Concentration: mg/100 g of dry soil)

| | | Total | Nitrate | Nitrite |
|---|---|---|---|---|
| Soils | pH | nitrogen | nitrogen | nitrogen |
| No slaked lime | 5.3 | 71 | 0.45 | 0.02 |
| Slaked lime (A) | 7.0 | 83 | 0.64 | <0.01 |
| 2 treatments (B) | 6.4 | 79 | 0.61 | <0.01 |
| 3 treatments (C) | 5.9 | 70 | 0.37 | <0.01 |
| 4 treatments (D) | 6.0 | 72 | 0.48 | 0.02 |

Assays: Total nitrogen (Kjeldahl method), nitrate nitrogen (titration method), nitrite nitrogen (colorimetric method)

F1 seeds of cabbage from Italy that had been stored for 1 week at 4° C. in a refrigerator were immersed in water for 3 hours prior to sowing for the germination test in exhaust gas-treated soil.

The test was carried out by placing 500 g of the four types of soil noted in TABLE 3, i.e., A, B, C, and D in each of 24 pots that were divided into 6 groups, and 22 cabbage seeds were sowed in each of the pots at different periods, i.e., immediately after exhaust gas treatment, 5 days after treatment, and 10 days after treatment. Immediately after sowing, 50 mL of water was added, and thereafter, 30 mL of water was added before the surface of the soil of each pot became dry. The groups A, B, C, and D were prepared in two sets, and the number of the average seed germinations of the two sets was calculated. The seed germination rates were calculated using the number of seed germinations in soil sample A as “100”, and the results are shown in TABLE 4.

TABLE 4
Germination rates of cabbage (%)

| | Same day | After 5 days | After 10 days |
|---|---|---|---|
| A | 100 | 100 | 100 |
| B | 147 | 128 | 183 |
| C | 116 | 178 | 141 |
| D | 129 | 142 | 183 |

There were no substantial differences in the germination rates of cabbage seed between the samples B, C, and D, which differed in the number of soil pasteurization treatments by exhaust gas from the tractor, and the germination rates for the cases in which exhaust gas treatment had been performed were better than those of the soil of the untreated sample A.

However, there were no differences in the soils of A, B, C and D due to the number of exhaust gas treatments in the germination rates of Japanese radishes cultivated in an outdoor field.

1. A soil pasteurization apparatus that uses exhaust gas from an engine of a tractor or other farm machine, characterized in comprising:
a pipe and a guide tube for guiding exhaust gas from the engine of the tractor or other farm machine;
a plurality of injectors for injecting exhaust gas into soil at branching terminal portions of the guide tube; and
a plurality of nozzles for injecting exhaust gas into the soil at the lower end portion of the injectors; wherein
the plurality of injectors can be drawn and made to travel through the soil.

2. The soil pasteurization apparatus according to claim 1, characterized in that:
exhaust gas from the engine of a tractor or other farm machine is introduced into a distribution tube in which an inner wall is an insulating structure employing a heat-resistant material through the above guide tube composed of said pipe and a flexible tube, of which an exterior is an insulating structure that employs a heat-resistant thermal insulator;
a plurality of branching tubes having flanges are welded to said distribution tube;
said injectors on which flat face flanges that correspond to the above flanges are connected to said distribution tube with the aid of bolts and nuts via heat-resistant packing; and
exhaust gas is sent into the soil from said plurality of nozzles disposed at the lower end portion of the injectors.

3. The soil pasteurization apparatus according to claim 2, characterized in that:
said distribution tube and said injectors integrated therewith are configured so as to be movable by large distances up and down in co-operation with a rotary device of said tractor; and
a manual elevating device is provided having a handle that can be rotated so that the depth of the injectors in the soil can be finely adjusted and set.

4. The soil pasteurization apparatus according to one of claims 2 and 3, characterized in that:
said injectors are boomerang-shaped plates that are curved in the forward direction, and the edges of the front and the rear of a boomerang-shaped plate are set at an acute angle so that the resistance received from the soil can be reduced during drawing through the soil;
said pipe, having a diameter that is slightly greater than the thickness of said boomerang-shaped plate, is welded and embedded in the middle of the plate;
said injectors having said pipe are inserted into the soil; and
said plurality of nozzles that can emit exhaust gas from the distal end of said pipe are provided.

5. The soil pasteurization apparatus according to claim 4, characterized in that:
an array of said branching tubes provided to said distribution tube is set in two horizontal rows so that the plate surfaces of all of the injectors are parallel, resulting in the resistance received from the soil in the forward direction being reduced when the injectors mounted on the branching tubes are drawn through the soil by the tractor; and
the arrays of a first row and a second row of injectors are set so as to mutually form a zigzag and not overlap each other, wherein the distal ends of all of these injectors are positioned at the same depth in the soil.

6. The soil pasteurization apparatus according to claim 5, characterized in that:
said injectors are disposed behind the rotary device so that the lower ends of said injectors can be inserted into and drawn through the soil while the soil is being cultivated.

7. A method of pasteurizing soil, characterized in that:
exhaust gas from an engine of said tractor is injected into soil using the soil pasteurization apparatus according to claim 1; and
the soil is pasteurized by the heat of the exhaust gas, or by the heat of the exhaust gas and the components of the exhaust gas.

8. The method of pasteurizing soil according to claim 7, characterized in that:
quicklime or slaked lime is applied in advance on the soil to be pasteurized;
exhaust gas is thereafter injected from the engine of said tractor into the soil; and
acidic fumes contained in the exhaust gas that are harmful to human health, the environment, and the like are fixed as calcium salts in the presence of moisture, whereby the harmful gaseous components are prevented from escaping into the atmosphere.
